(19) United States
(12) Patent Application Publication
(10) Pub. No.: US 2026/0159014 A1
(43) Pub. Date: Jun. 11, 2026

(54) Vehicle License Plate Frame with Two Integrated Photo Frames

(71) Applicant: Syed Qasim Raza, Tracy, CA (US)

(72) Inventor: Syed Qasim Raza, Tracy, CA (US)

(21) Appl. No.: 19/387,907

(22) Filed: Nov. 13, 2025

Related U.S. Application Data
(60) Provisional application No. 63/720,538, filed on Nov. 14, 2024.

(51) Int. Cl. B60R 13/10

(52) U.S. Cl. CPC B60R 13/105

(57) ABSTRACT

A vehicle license plate frame comprising a frame body with upper, lower, and side borders, the side borders each defining a concealed sliding photo frame assembly. Each photo frame contains a photo plate and a transparent protective film for displaying photographs or decorative images. A detachable stopper attaches from the rear of the frame body to limit the sliding movement of the photo frames and prevent full removal. The frame body and its components are made of metallic or plastic materials to provide strength, lightweight performance, and weather resistance. When closed, the photo frames are concealed within the side borders, maintaining a conventional outward appearance while enabling personalization and protection of inserted images.

### CROSS-REFERENCE TO RELATED APPLICATIONS

This application claims the benefit of U.S. Provisional Patent Application No. 63/720,538, filed on Nov. 14, 2024, the contents of which are incorporated herein by reference.

### FIELD OF INVENTION

The present invention pertains broadly to vehicle license plate frames, with particular emphasis on a license plate frame that integrates dual sliding photo frame assemblies within its structure for the purpose of displaying and safeguarding personal and commercial signage, branding decals, and decorative or personalized images and photos.

### BACKGROUND OF THE INVENTION

Standard license plate frames are primarily designed for decorative or protective purposes around vehicle license plates. Conventional frames typically consist of rigid borders with fastening apertures for mounting and lack provisions for additional functional or aesthetic customization.

Vehicle owners often seek a means of displaying commercial signage or personalizing their vehicles without compromising the vehicle's appearance or altering the overall look or compliance of the license plate area. There exists a need for a license plate frame that incorporates interchangeable display features within its body, enabling effortless personalization while preserving a conventional outward appearance and compatibility with standard license plate mounting systems.

### SUMMARY OF THE INVENTION

The invention discloses a vehicle license plate frame integrating retractable dual sliding photo frames within its side borders. Each photo frame assembly comprises a photo frame with a transparent protective thin film for displaying and safeguarding signage, photographs, or decorative images.

The innovative frame is engineered to be fabricated from a variety of robust materials, including plastic, metal, or any other strong material, and may be produced in any desired color. The principal section is specifically designed to accommodate and display a standard vehicle license plate. Flanking this main frame area, the two subsidiary retractable photo frames are intended for the prominent exhibition of a wide range of items, such as signs and warnings (for example, new driver, learner driver, baby on board), personalized messages (including but not limited to I love my mom, veteran status, New York Yankees fan or A Republican Voter), photographs, commercial branding, transportation decals or permits (such as those for Uber, Lyft, or Taxi services), and any other content that conforms to the spatial limitations of the frames and is legally permissible for display.

The two photo frames slide laterally through openings in the side borders and are retained by detachable rear-mounted stoppers that prevent full withdrawal during operation. When closed, the photo frames remain concealed, preserving the conventional appearance of a standard license plate frame. This design enables users to easily insert, replace, or protect signs/photos without tools, maintaining durability, weather resistance, and compatibility with standard vehicle mounting systems.

### BRIEF DESCRIPTION OF THE DRAWINGS

FIG. 1 is a 3D front perspective view of the license plate frame in a closed position.

FIG. 2 is a 3D rear perspective view of the license plate frame in a closed position.

FIG. 3 shows orthographic views of the license plate frame.

FIG. 4 is a 3D front perspective view of the license plate frame in an opened state, showing the photo frame extended.

FIG. 5 is a 3D rear perspective view of the license plate frame in an opened state.

FIG. 6 is an exploded view illustrating the components of the license plate frame, including the photo frames, photo plates, thin films, stoppers, and screw aperture pieces.

FIG. 7 shows the 3D front and rear views of the license plate frame.

FIG. 8 shows the 3D front and rear views of the photo frame component.

FIG. 9 shows the 3D front and rear views of the photo plate.

FIG. 10 illustrates the transparent photo thin film.

FIG. 11 shows the 3D view of the photo frame stopper.

FIG. 12 shows the 3D view of the screw aperture piece.

FIG. 13 shows the geometrical data of the license plate frame assembly.

FIG. 14 shows the geometrical data of the license frame.

FIG. 15 shows the geometrical data of the photo frame.

FIG. 16 shows the geometrical data of the photo plate.

FIG. 17 shows the geometrical data of the thin film.

FIG. 18 shows the geometrical data of the photo frame stopper.

FIG. 19 shows the geometrical data of the screw aperture piece.

FIG. 20 gives the part list for the license plate frame.

### DETAILED DESCRIPTION

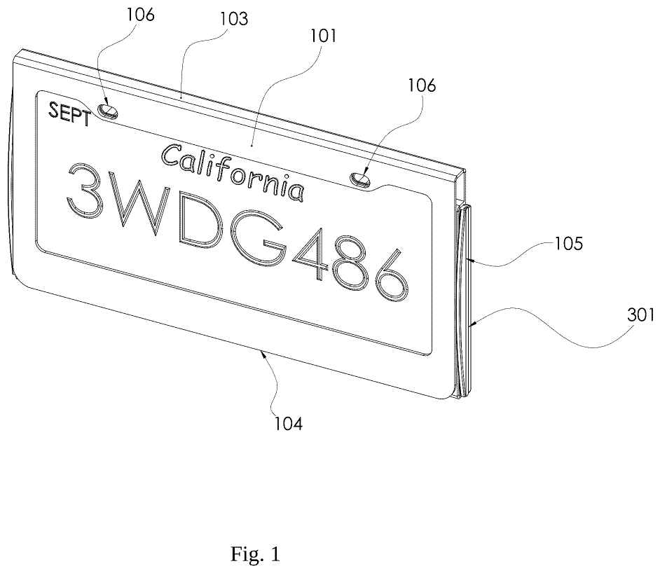

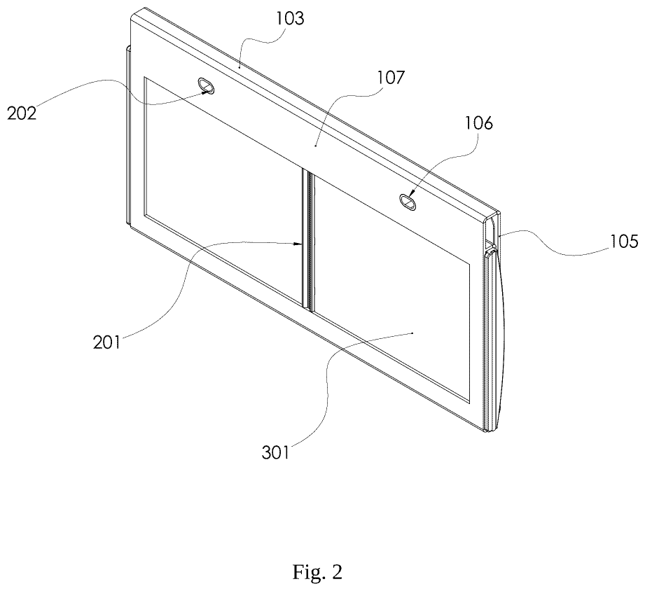

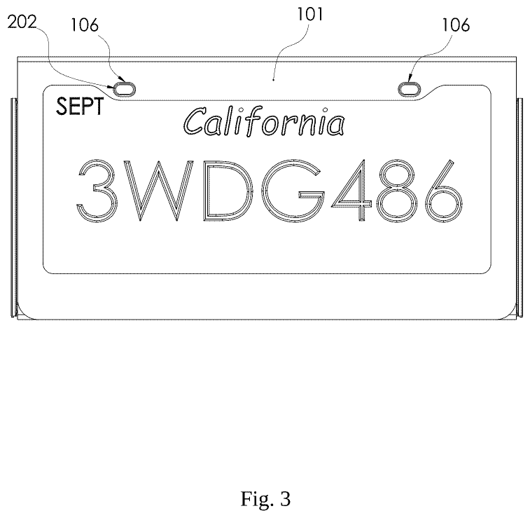

Referring to FIGS. 1-3, the vehicle license plate frame (100) includes a frame body (101) defining a license plate mounting surface (102). The frame body comprises an upper border (103), a lower border (104), and opposing side borders (105). Fastening apertures (106) are formed through the frame body for attachment to a vehicle using conventional mounting screws. The rear surface of the frame body is indicated as (107).

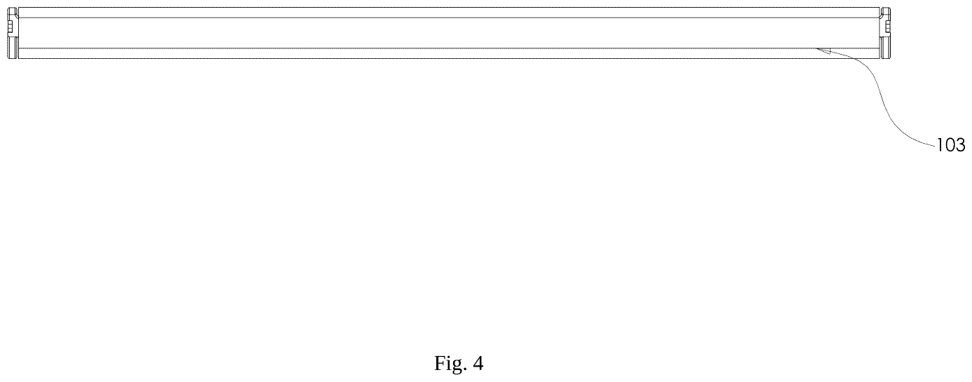

As shown in FIGS. 4-6, each side border (105) has an opening area configured to receive a photo frame (301). The photo frame (301) slides laterally into and out of the frame body (101) through the corresponding side border. Each photo frame contains a photo plate (303) positioned within a photo placement area (305). A transparent photo thin film (304) is placed over the photo plate (303), forming a protective layer for the inserted photograph or decorative image.

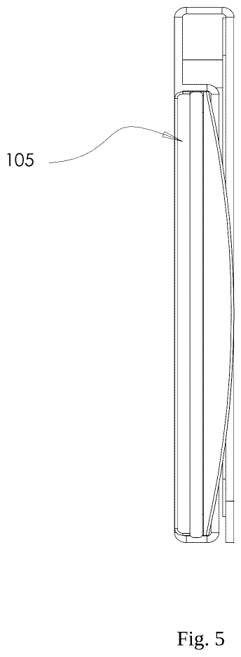

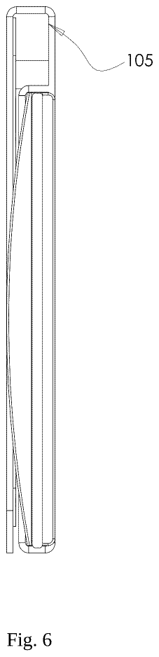

Referring to FIGS. 5-6 & 11-12, a detachable photo frame stopper (201) and a screw aperture piece/insert (202) are attached from the rear surface (107) of the frame body. The stopper (201) clips into the rear side of the corresponding photo frame (301) and includes protruding portions that function as travel-limit stops, preventing the photo frame from sliding out completely during opening. The stopper is detachable, allowing maintenance or replacement when necessary. The screw aperture piece/insert (202) functions as a guide for the screws inserted from the front of the license plate frame and attaches the frame with the plate to the car body.

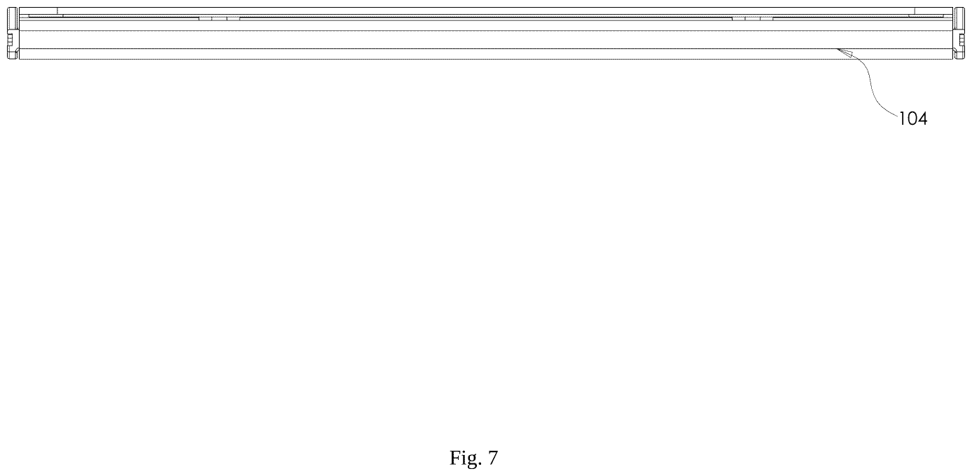

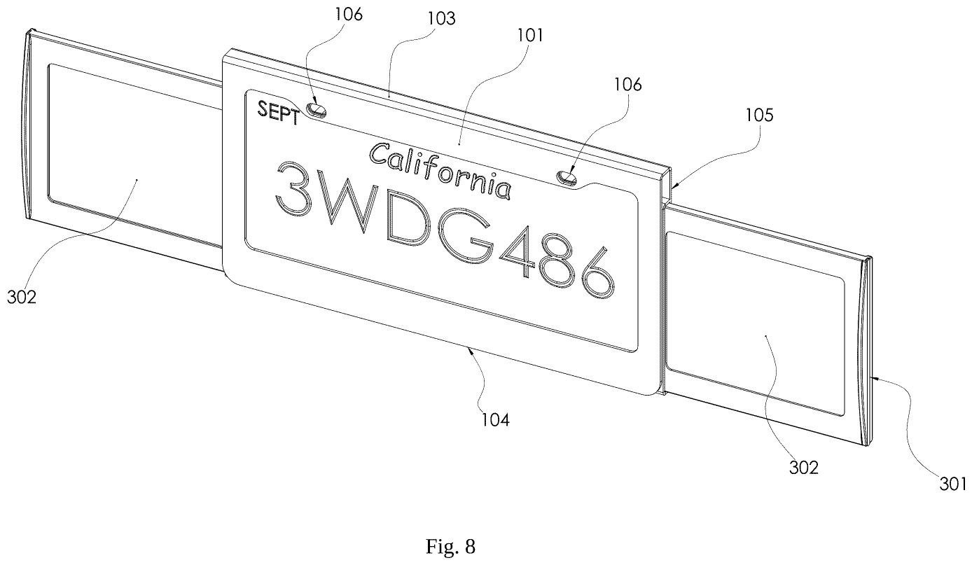

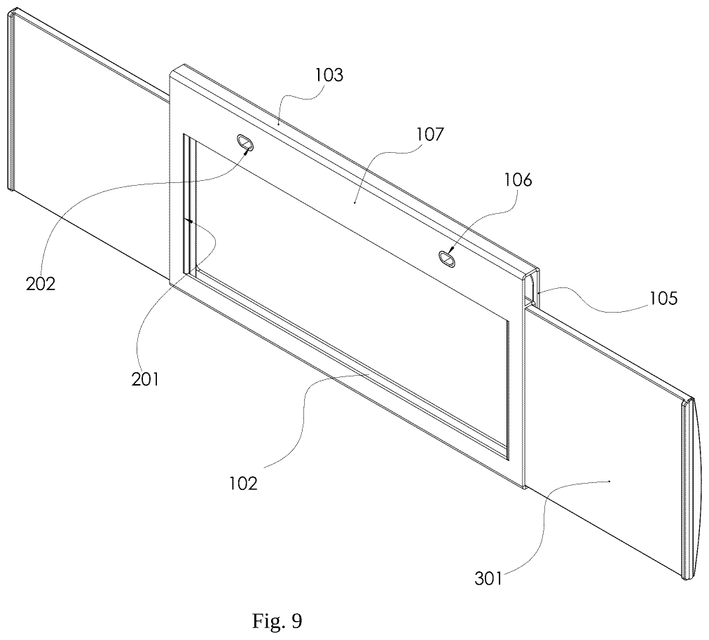

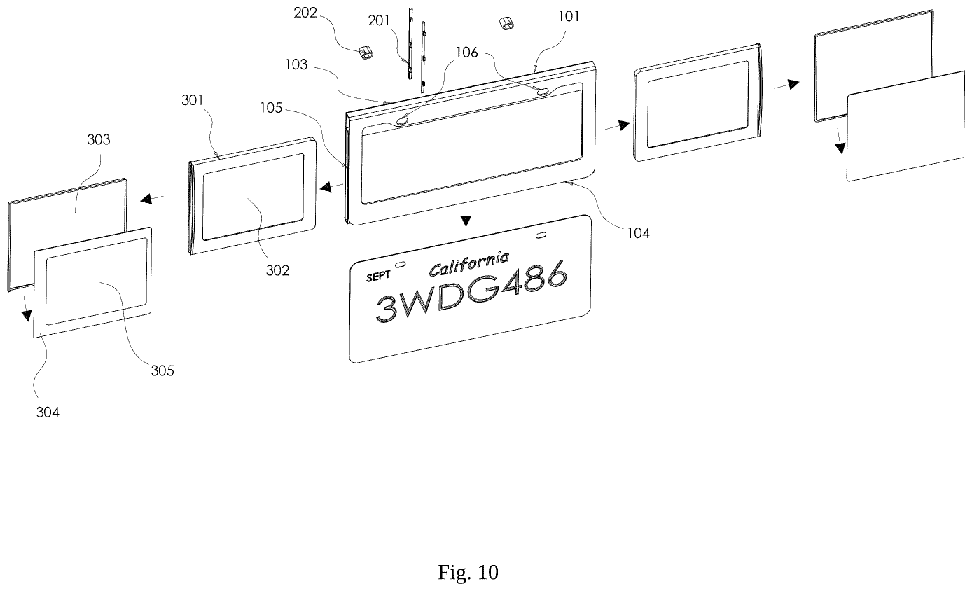

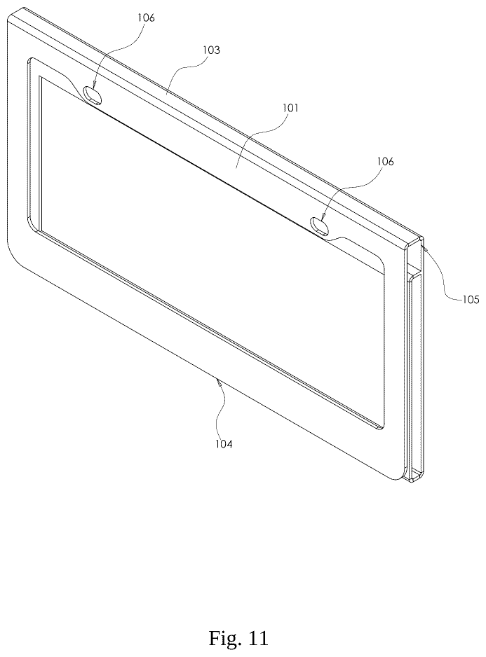

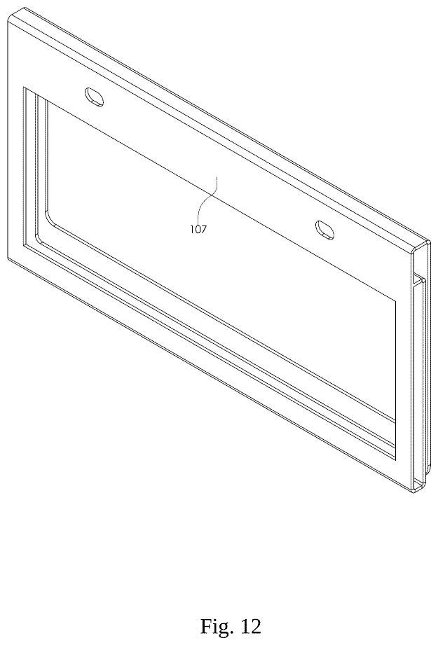

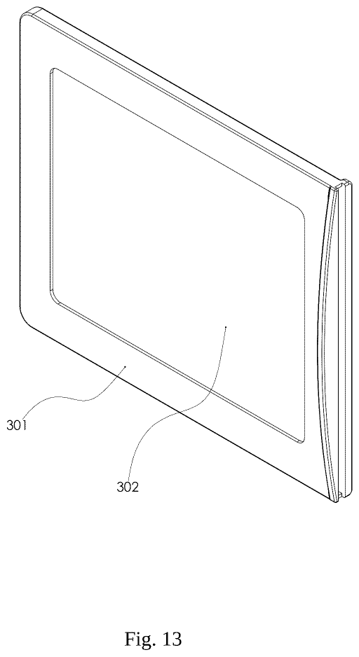

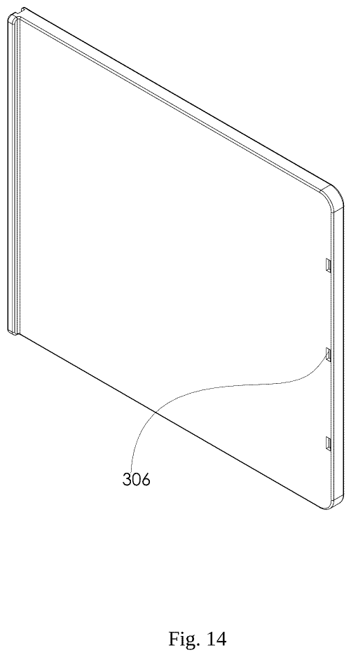

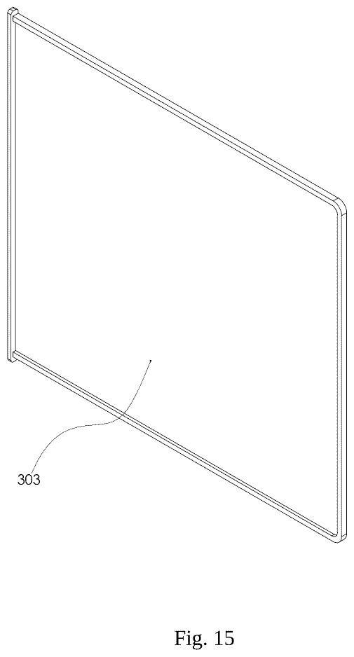

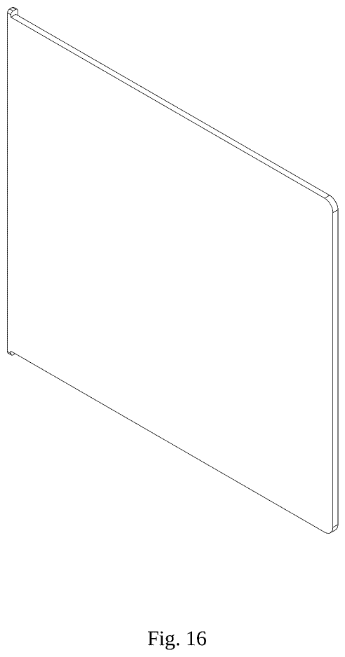

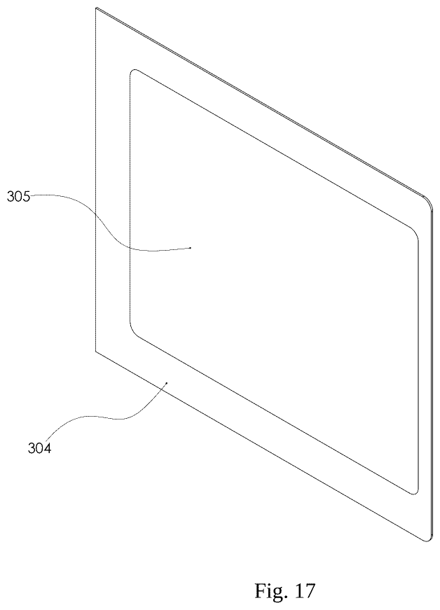

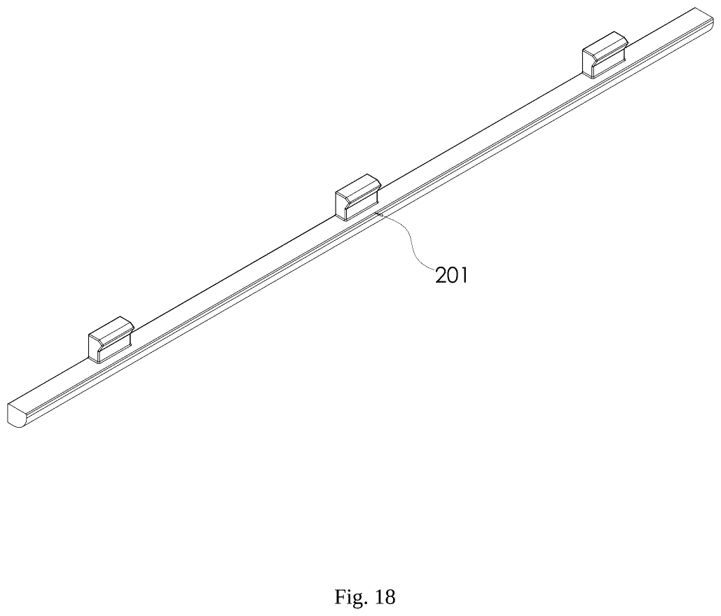

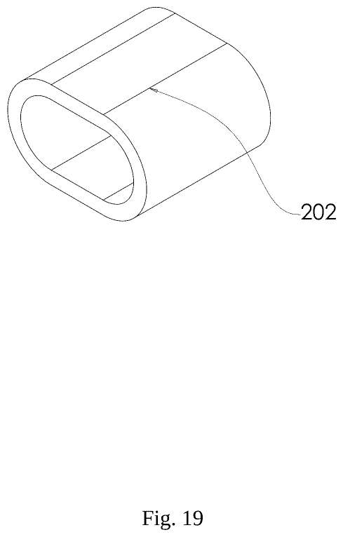

As depicted in FIGS. 6-10, there are two photo frame assemblies-one inserted through the left side border and one through the right side border of the license plate frame. Each assembly includes one photo frame (301), one photo plate (303), and one photo thin film (304). The assemblies slide independently, allowing users to open either side to insert or replace a sign/photograph, or artwork.

The frame body and its components may be formed from metallic materials such as aluminum or stainless steel for enhanced strength and durability, or from high-strength plastics such as ABS or polycarbonate for reduced weight and cost efficiency. Surface finishes may include anodizing, powder coating, or paint for metals, and gloss or matte texturing for plastics.

When both photo frames are retracted, they rest flush within the side borders (105), and the frame body (101) presents a smooth, conventional appearance identical to a standard vehicle license plate frame. This concealed design allows for personalization while maintaining weather resistance, mechanical stability, aesthetic uniformity, and compliance.

1. A vehicle license plate frame comprising: a frame body configured to receive a license plate; and at least one additional display frame located within the frame body.

2. The vehicle license plate frame of claim 1, wherein the frame body defines a license plate mounting surface at the front.

3. The vehicle license plate frame of claim 1, wherein the additional display frame is integrated behind the license plate within the side border.

4. The vehicle license plate frame of claim 1, wherein the additional display frame houses a plate for photo placement.

5. The vehicle license plate frame of claim 1, wherein the additional display frame housing a transparent thin protective film.

6. The vehicle license plate frame of claim 1, wherein a detachable stopper is attached to the additional display frame from the rear of the frame body, preventing complete withdrawal from the frame body.

7. The vehicle license plate frame of claim 1, wherein two screw aperture pieces function as a guide for the screws inserted from the front of the frame body, and attach the frame to the vehicle body.

8. The vehicle license plate frame of claim 1, wherein the frame body and at least one component are formed of metallic or polymeric materials selected to provide strength, weather resistance, and durability.

9. A vehicle license plate frame comprising: a frame body for displaying a license plate and two photo frames, each integrated into a side border.

10. The vehicle license plate frame of claim 9, wherein the frame body has a front license plate mounting space.

11. The vehicle license plate frame of claim 9, wherein the photo frames are integrated into each side of the frame body.

12. The vehicle license plate frame of claim 9, wherein each of the photo frames includes a photo holder for photo placement.

13. The vehicle license plate frame of claim 9, wherein the photo holders within each photo frame are designed to hold a transparent thin film for photo protection.

14. The vehicle license plate frame of claim 9, wherein each photo frame incorporates a stopper in the back that clips in from the rear of the frame body, preventing complete removal from the frame.

15. The vehicle license plate frame of claim 9, wherein two screw guide pieces are inserted into the frame body's screw apertures from the rear to facilitate secure mounting of the license plate.

16. The vehicle license plate frame of claim 9, wherein the frame body and at least one component are formed of metallic or polymeric materials selected to provide strength, weather resistance, and durability.

17. A method of using a vehicle license plate frame, comprising: attaching the license plate to a vehicle; and opening at least one additional frame integrated within the frame body.

18. The method of claim 17, wherein inserting the license plate includes the lifting of the lower front border of the frame body.

19. The method of claim 17, wherein opening the additional frame comprises accessing a handle positioned on the outer edge of the retractable frame located at the rear of the frame body.

20. The method of claim 17, wherein adding a photo involves pulling the photo holder out from the side of the additional retractable frame and removing the transparent protective thin film.

21. The method of claim 17, wherein holding the additional frame upright in expanded position comprises adding a detachable stopper designed to clip into the back.
